(19) United States
(12) Patent Application Publication
(10) Pub. No.: US 2016/0225275 A1
(43) Pub. Date: Aug. 4, 2016

(54) SYSTEM AND METHOD FOR RESPONSIVE TEACHING AND LEARNING

(71) Applicant: LEARNOLOGY PTY LTD, Williamstown, Victoria (AU)

(72) Inventors: Colin WOOD, Williamstown (AU); Stuart MITCHELL, Seddon (AU)

(73) Assignee: Learnology Pty Ltd, Williamstown, VI (AU)

(21) Appl. No.: 15/021,759

(22) PCT Filed: Sep. 14, 2014
(86) PCT No.: PCT/AU2014/050229

§ 371 Date: Mar. 14, 2016

(30) Foreign Application Priority Data
Sep. 14, 2013 (AU) 2013903541

(51) Int. Cl. G09B 7/073; G09B 5/08; G09B 7/02; G09B 5/06

(52) U.S. Cl. CPC G09B 7/073; G09B 5/065; G09B 5/08; G09B 7/02

(57) ABSTRACT

A system for responsive teaching and learning comprising: an educator module that provides an educator interface facilitating uploading of lesson content; a lesson content database in communication with the educator module and adapted to receive the lesson content; a student module adapted to receive the lesson content and providing a student interface facilitating responses to the lesson content; a response database in communication with the student module and adapted to receive the responses from the students; a response management module that identifies responses made by students and, on receiving a predetermined minimum response requirement, releases responses essentially anonymously from other students to that student thereby facilitating essentially anonymous interaction between students; wherein the responses from the students and the essentially anonymous interactions are available to the educator and can be analysed by the educator and students within the student population grouped based on the responses and the anonymous interactions.

### FIELD OF INVENTION

The present invention relates to a system and method for responsive teaching and learning. In particular, the invention relates to a system and method that facilitates delivery of content from an educator to a student population, response from students within the student population, assessment of those responses and collaboration within the student population. The system and method also provides an opportunity to effectively group students within the student population in view of the student responses received.

### BACKGROUND ART

In traditional classrooms, teachers generally make assumptions about learning based on a number of factors. These may include, for example, unreliable data such as numbers of hands up, body language and student responses to homework and discussions in environments where students are influenced heavily by a desire to have the “right answer”, to conform to externally imposed expectations and positive and negative peer pressure.

This problem has been partially addressed with the onset of online learning communities, which allow learning to be extended beyond the physical and temporal constraints of the classroom as students use online discussion forums to respond to teacher initiated stimuli. However, despite affording every student a voice, students are still functioning under the same constraints, with their posts being viewed by their peers and teacher and, as such, student responses still reflect a desire to conform and to bow to peer pressure. Furthermore, in these traditional online communities, because students can see who has posted, each student response is influenced by the responses that have gone before and do not necessarily reflect authentic sentiments. Also, in traditional online discussions, teachers have to manually check to see which students have posted comments and met the requirements of any given assignment. This alone frequently dissuades teachers from requiring students to collaborate online.

Online discussion environments can also be overwhelming, with long lists of responses of varying quality, with ideas repeated and presented in a linear fashion that does not support the teacher in making sense of the data. Such environments do not offer functionality that allows manipulation of student feedback in a way that will support teaching and learning. If learning is to be made visible, there should be a connection between what students say online and any ensuing teacher practice offline.

Teachers who have embraced blended learning approaches, which offer students access to both online and offline learning opportunities, have been experimenting with multiple applications to create, curate, deliver and manage content and student responses to content using a combination of applications. Traditionally, teachers have been using video and podcasting software to create educational content and then online repositories such as YouTube or Google Drive to curate resources ready for sharing with students in online discussion forums, presented in online learning management systems, class blogs or websites.

The challenge facing teachers has been how to get started and for many, the required investment in time and the technological learning curve has proven to be too great a barrier to entry. This results in these contemporary, proven learning opportunities being provided by only a small group of the most innovative practitioners. Assuming those innovative practitioners engage in the contemporary online tools there is still a huge challenge in transferring/continuing the value into the offline classroom. Therefore the two worlds often operate in isolation and do not deliver the combined value.

The subject matter claimed herein is not limited to embodiments that solve any disadvantages or that operate only in environments such as those described above. Rather, this background is only provided to illustrate one exemplary technology area where some embodiments described herein may be practice.

### SUMMARY OF INVENTION

One aspect of the present invention provides a system for responsive teaching and learning comprising:
an educator module that provides an educator interface facilitating uploading of lesson content by an educator;
a lesson content database in communication with the educator module and adapted to receive the lesson content from the educator;
a student module adapted to receive the lesson content and providing a student interface facilitating responses to the lesson content from students within a student population;
a response database in communication with the student module and adapted to receive the responses from the students;
a response management module that identifies responses made by students within the student population and, essentially on receiving a predetermined minimum response requirement from a student, releases responses essentially anonymously from other students within the student population to that student thereby facilitating essentially anonymous interaction between students;
wherein the responses from the students and the essentially anonymous interactions are available to the educator whereby the responses and the anonymous interactions can be analysed by the educator and students within the student population grouped based on the responses and the anonymous interactions.

It is noted that the invention essentially requires that a student satisfy the predetermined minimum response requirement before responses from other students are released to that student. Also, the invention essentially requires that interactions between students be anonymous.

The rigorous workflow outlined above and discussed in more detail below in respect of further aspects of the invention, essentially requiring that students meet the minimum predetermined response requirement and anonymous interactions between students, defines a process that challenges students to respond and collaborate with their class.

As users are engaged in this defined workflow, the system preferably scores and records data for students and teachers consistently across each activity. This data represents each student's capacity to learn in an essentially anonymous environment and each teachers effectiveness in engaging students through different types of questions and stimuli.

The system may record the quantity and quality of student contributions, assessed by number of student comments on one another's responses together with student ‘likes’ awarded to valued contributions in the essentially anonymous collaboration space. This unique data set is the result of the unique process of the invention. The system may collect and calculate scores showing progress and engagement over time. These scores provide the user (both teacher and learner) with feedback on their improvement over time for each activity set.

The form of the lesson content is not particularly limited. For example, this may comprise audio, video or images recorded by the educator on an educator device, and/or content sourced from an external source. The educator device may be, for example, a smart phone or tablet, or laptop or desk top computer. The external source will generally be the internet.

The response management module may release responses from the students across the student population when all of the students within the student population have satisfied the predetermined minimum response requirement. In another embodiment, the response management system releases responses from students within the student population only to students who have fulfilled the predetermined minimum response requirement. In this embodiment, the released responses are generally limited to responses from students who have fulfilled the predetermined minimum response requirement.

The anonymous interactions may comprise, for example, tagging student responses with one or more of the group comprising “Agree”, “Disagree”, “Helpful”, “Like”, “Me Too”, and/or comments on student responses.

In certain embodiments, the system may additionally comprise a dashboard adapted to collate learning data generated from the responses and the anonymous interactions in real time from one or more student population. For example, this may be a dashboard that collates learning data from across a school population comprising a number of student populations corresponding with classes or class levels within the school. A broader dashboard may also be in place, for example across a state, territory or country.

According to another aspect of the invention there is provided a method for responsive teaching and learning comprising;
delivering lesson content from an educator interface to student interfaces within a student population;
establishing a predetermined minimum response requirement from students within the student population;
receiving responses from the students within the student population, through the student interfaces;
essentially identifying when a student satisfies the predetermined minimum response requirement;
when a student within the student population satisfies the predetermined minimum response requirement, making available to that student through their respective student interface, essentially anonymously, responses from other students within the student population;
receiving essentially anonymous interactions from students within the student population relating to responses from other students within the student population; and
based on the responses from students and the essentially anonymous interactions, establishing student groupings within the student population.

The method preferably comprises scoring and recording data for students and teachers across each activity. As noted above, this data represents each student's capacity to learn in an essentially anonymous environment and each teacher's effectiveness in engaging students through different types of questions and stimuli.

The method may also comprise recording the quantity and quality of student contributions, assessed by number of student comments on one another's responses together with student ‘likes’ awarded to valued contributions in the essentially anonymous collaboration space. The process may comprise collecting and calculating scores showing progress and engagement over time. As noted above, these scores provide the user (both teacher and learner) with feedback on their improvement over time for each activity set.

Again, the lesson content is not particularly limited and may comprise audio, video or images recorded by the educator on an educator device, and/or content sourced from an external source.

Likewise, student responses may be released from the students across the student population when all of the students within the student population have satisfied the predetermined minimum response requirement. Alternatively, responses may be released from students within the student population only to students who have fulfilled the predetermined minimum response requirement. If so, the released responses may be limited to responses from students who have fulfilled the predetermined minimum response requirement.

As with the above described system, the anonymous interactions may comprise tagging student responses with one or more of the group comprising “Agree”, is “Disagree”, “Helpful”, “Like”, “Me Too”, and/or commenting on student responses.

The method may also additionally comprise collating learning data generated from the responses and the anonymous interactions from one or more student population.

According to a further aspect of the invention there is provided a computer readable medium containing programming instructions that cause a computer processor to perform the steps of:
delivering lesson content from an educator interface to student interfaces within a student population;
establishing a predetermined minimum response requirement from students within the student population;
essentially identifying when a student satisfies the predetermined minimum response requirement;
when a student within the student population satisfies the predetermined minimum response requirement, making available to that student through their respective student interface, essentially anonymously, responses from other students within the student population;
facilitating essentially anonymous interactions from students within the student population relating to responses from other students within the student population; and
based on the responses from students and the essentially anonymous interactions, enabling student groupings within the student population.

The features referred to above in respect of the method of the invention are also applicable to this aspect of the invention and are explicitly incorporated herein.

In summary, unlike some earlier methodologies, always requires a unique contribution from a student prior to seeing classmates responses. The teacher is provided with original contributions from each student allowing formative assessment to be made. Student-to-student interactions are always anonymous leading to higher levels of peer-to-peer interaction. The teacher is thereby able to assess qualitatively students' capacity to collaborate and co-operate. The teacher is generally presented with data showing the quantity of student-teacher interactions on a topic, the quantity of peer-to-peer interactions, and the quality of peer-to-peer interactions (peer-assessment). The teacher can thereby group student responses, which may inform the teachers next teaching plan and physical grouping of students.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a system for responsive teaching and learning of an embodiment of the invention.

FIG. 2 illustrates a method for responsive teaching and learning of an embodiment of the invention.

### DETAILED DESCRIPTION OF THE PREFERRED EMBODIMENTS

As mentioned above, the present invention provides a system and method for responsive teaching and learning. In particular, the invention relates to a system and method that facilitates delivery of content from an educator to a student population, response from students within the student population, assessment of those responses and essentially anonymous collaboration within the student population. The system and method also provides an opportunity to effectively group students within the student population in view of the student responses received.

Hereinafter, the present invention will be described in more detail according to the preferred embodiments. It is to be understood that limiting the description to the preferred embodiments of the invention is merely to facilitate discussion of the present invention. Alternatives and modifications to the preferred embodiments may be understood and appreciated by those of skill in the art and are included within the ambit of the invention without departing from the scope of the appended claims.

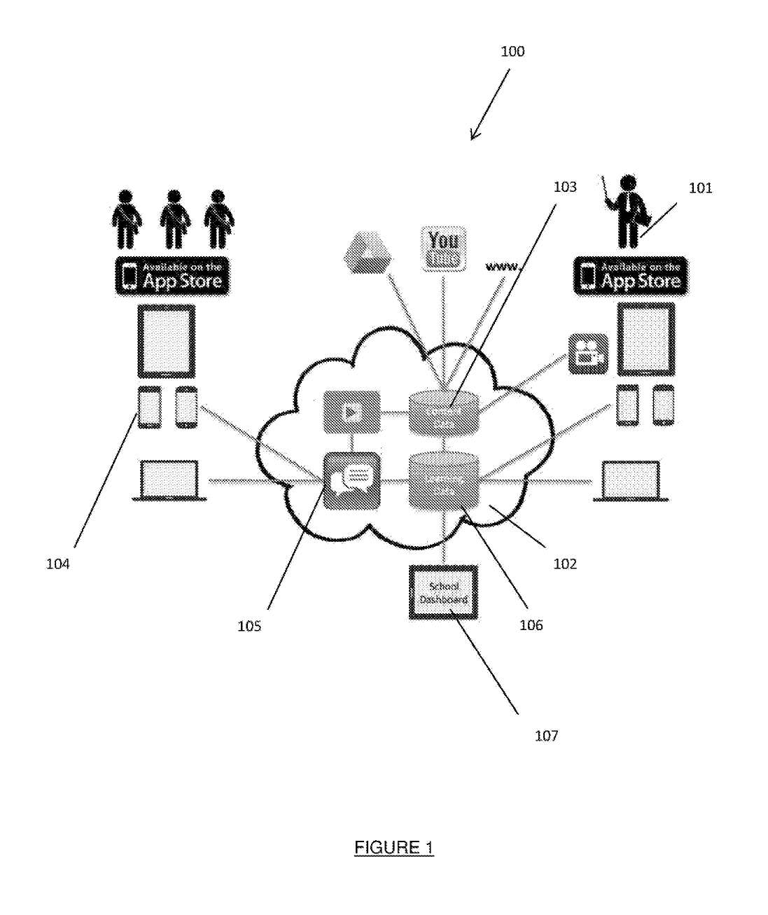

Referring to FIG. 1, a system 100 for responsive teaching and learning is illustrated. The system includes educator module software stored on at least one educator device 101. The system 100 connects the educator device 101, via the web 102, with a content database 103 stored on a server that maintains lesson content. Lesson content can be loaded to the content database 103 by an educator through their educator device 101. This may include video content or other content loaded directly or indirectly to the content database 103, for example, through YouTube or Google Drive or any other suitable mechanism.

A student population is provided with student module software that is stored on student devices 104. This facilitates connection of the student devices 104 with the content and collaboration space 105.

When lesson content is loaded onto the content database 103, it can then be made available to the student population via the content and collaboration space 105 and accessed on the student devices 104. On receiving the lesson content, students are essentially required to provide a predetermined number of responses in the content and collaboration space 105 before responses of other students are released or “unlocked” and thereby made visible to them. In this way, students are not influenced by the responses in the content and collaboration space 105 of other students. When a student satisfies the predetermined response requirement, responses in the content and collaboration space 105 from other students are made available, but essentially remain anonymous. That is, the identity of the student making any particular response in the content and collaboration space 105 is not available to the student population. As such, again, students are not influenced by the responses of other students, for example due to peer group pressure or a desire to conform to any particular student or group of students, ensuring a more genuine forum is achieved.

The identity of students making responses is available to the educator and, as such, the educator can identify students within the student population that have made responses in the content and collaboration space 105 and take suitable action where responses in the content and collaboration space 105 have not been submitted by any particular student. Responses and associated learning data in the content and collaboration space 105 from the student population are stored in a learning database 106 associated with the system 100.

On releasing responses from the students the student population, albeit anonymously, students within the student population may comment on the responses in the content and collaboration space 105. For example, students may agree or disagree with comments of other students, or “like” the comments, or indicate them as “helpful”.

Armed with the information collected from the student population, based on the responses of the students, the educator can adapt lesson content for use in the classroom. The educator is also placed in a position of being able to effectively group students, based on their responses, within a classroom environment. That is, an educator will be able to plan the lesson activities based on the learning needs of their students.

The system 100 may also be in communication with a school dashboard 107 that facilitates analysis of teacher effectiveness, learning effect and student engagement, based on student responses in the content and collaboration space 105 and educator content 103, across a year level, or across an entire school. On another level, it is envisaged that an even broader analysis may be possible based on learning data collected from schools and available on school dashboards 107. For example, an overview of education within a state or territory, or even country, may be available for analysis (i.e. based on results available on any number of school dashboards 107).

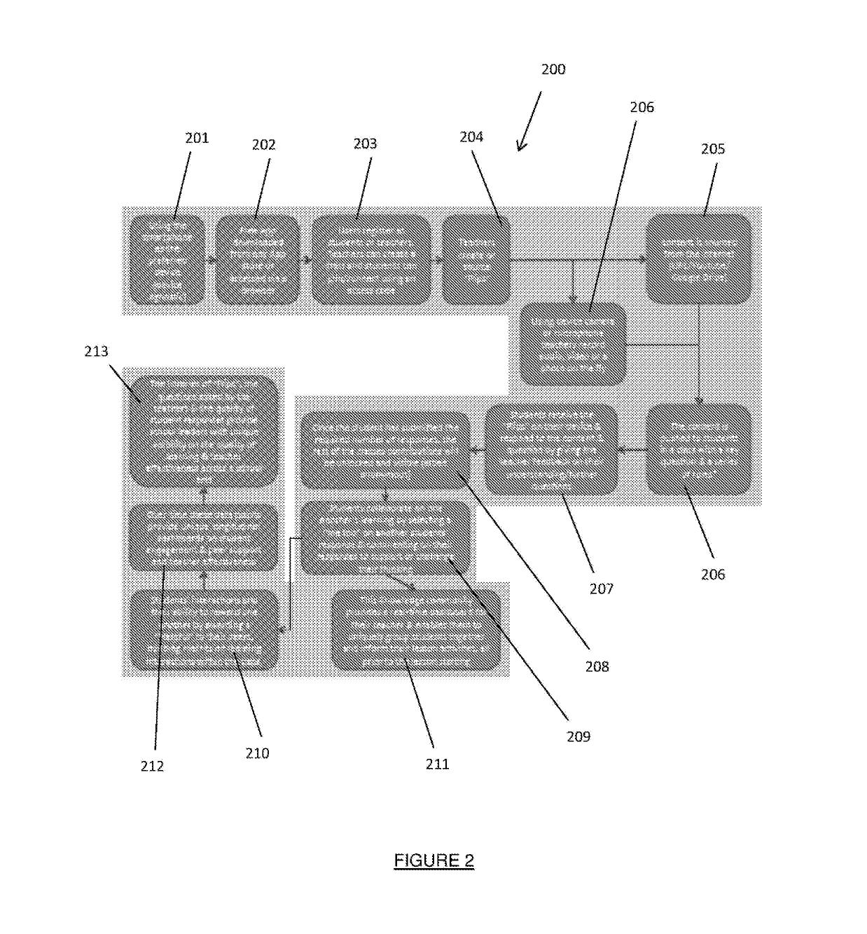

Turning to FIG. 2, a method 200 of responsive teaching and learning is illustrated. The method 200 is based on the premise that students within the student population will have a device, for example a smartphone or tablet available to them 201. Based on this assumption, a free App is downloaded 202 onto student devices, for example via an App store, or may be accessed via a browser. Users can then register 203 as students or educators, making student or educator modules available to the users. Registration 203 makes it possible for educators to create virtual spaces for students to join or connect, for example using an access code.

Once the student population and educator are registered on the system, teachers must create or source 204 lesson content, or “Flips”. Lesson content may be sourced from the internet 205 (i.e. URL/YouTube/Google Drive), or may be sourced by the educator device 206. For example, using the educator device camera or microphone an educator may record audio, video or image “on the fly” and use this as the basis for lesson content (stimuli).

Once lesson content has been created 204, 205, 206, the content is pushed 207 to the students in a class, generally with a key question and a series of rules. Rules may include, for example, the number of responses required from the students and the requirement for anonymity. Students receive the lesson content, or “Flips”, on their devices and respond 208 to the lesson content and question posed by the educator, thereby giving the educator feedback on their understanding and possibly posing further questions.

Once a student has fulfilled the essential response requirement set by the educator, generally by submitting the required number of responses, contributions of the rest of the student population will be unlocked 208 and visible to the student, albeit essentially anonymously. Collaboration and anonymous interaction 209 within the student body is then facilitated, with students being able to interact in respect of one another's learning by, for example, selecting a “me too” on other students' responses, or commenting on their responses to support or challenge their thinking. Metrics on learning interactions within the class may be built 210 based on the student interactions and their ability to reward one another, for example by awarding a “Helpful” to their peers based on responses from their peers.

The “Knowledge Community” created provides a real-time dashboard for the educator, enabling them to uniquely groups students together and inform their lesson activities within the classroom 211 prior to the lesson starting.

Over time, data points collected may be used to provide a unique longitudinal dashboard on student engagement, peer support and educator effectiveness 212. The lesson content library of the system containing the content or “Flips” and questions asked by the educator, and the learning database containing the student responses and quality of responses from the students advantageously provide school leaders with unique visibility on the quality of learning and teacher effectiveness across a school 213.

The system 100 and method 200 of the invention advantageously removes barriers by providing tools, processes, workflow support and data required, in one easy-to-use web-based App that is capable of working on devices that students and teachers bring to class or use at home. It uniquely allows teachers to use familiar consumer technologies to create, curate and share educational content with their students in easily managed discussion spaces that offer visibility on learn ing, along with longitudinal data about student participation, levels and quality of engagement and online learning relationships.

The invention advantageously aims to overcome issues of currently available systems and methods by offering teachers visibility on authentic responses from every student, enabled by the essentially anonymous environment. This is also achieved through restricting access to class comments until a student, potentially every student, has posted a required number of initial responses to any given stimulus. Once a student has made the required number of posts, the class forum is unlocked, allowing the student to view and comment on the posts of other students who have also made sufficient posts to unlock the broader class discussion.

The system and method of the invention also advantageously offers teachers real time data, which identifies students that have yet to engage, allowing intervention prior to deadlines. The invention therefore advantageously not only provides a dashboard on the quantity, but also the quality of engagements. In certain embodiments the invention allows students and teachers to “like” any comment that has been made in response to a student's own initial post. This awards a score to the respondent, and both the respondents and the teacher can view scores for each activity alongside longitudinal data representing progress over time. This uniquely encourages students to focus on producing higher quality responses to posts made by their peers whilst offering the teacher data that supports effective intervention with regards to developing collaboration and communication skills.

Embodiments of the present invention offer unique functionality that allows the teacher to group together similar student initiated questions, opinions and facts and group them in many ways as ideas, higher-order thinking or misconceptions. By selecting similar student responses, the teacher can select to “group” these together, effectively filtering student comments into groups that require a similar teaching point, or which may influence physical groupings within the classroom, allowing for targeted support to be delivered in class, in direct response to student feedback.

These class interactions provide unique, authentic observations on teacher effectiveness otherwise only achieved through viewing isolated online environments or attendance in physical classroom spaces. The system and method of the invention may therefore advantageously connect online learning and offline classroom practice making it possible for school leaders to efficiently observe individual authentic student responses to teacher questioning and how that relates to curriculum objectives. As each teacher user is connected via their common school, teacher data may be aggregated providing unique dashboards to school principals.

Data obtained, due to the essentially anonymous nature of the environment, may illustrate where an individual student's qualitative responses sit in relation to those of their peers. This data could be used to assist parent-teacher (or other parent-school) interactions. For example, a parent could be shown where their child's work, responses and/or learning sits in relation to their classmates while still preserving the anonymity of all other students. This will advantageously allow the parent to see first-hand the context in which the teacher's formative assessment is taking place.

The data may also be used to show how a student engages with one teacher versus another (or indeed across all of their teachers). Because the content delivery methods are standardised and because engagement data is collected in a standardised fashion and in an essentially anonymous environment, student “engagement” data is normalized in the database across classes and teachers. Anomalous engagement data can then be surfaced programmatically to highlight where a student is engaging with one teacher above their average engagement levels with other teachers, or above the average for their peers, or indeed across the school. This can be used to infer such things as learning dispositions and can inform the class timetabling process (i.e. which students are placed with which teachers)

The data may further be used to show how a student engages in one subject area compared to another (or indeed across subject areas). As data may be tagged against curriculum indicators (Year and subject area), a student's engagement level can be monitored and alerts set based on performance thresholds or trend analysis. This can be used to identify intervention requirements (i.e. a student's engagement is dropping in mathematics).

Still further, the data may be used to show how a student engages with different types of teacher questions and stimuli (e.g. photo, video, document, audio recording, etc.). This again can advantageously highlight different learning dispositions. For example, it may be reported by the system that a particular student only engages well with video learning materials

The data may also illustrate the levels of engagement that different teachers are getting from their students. Again the normalised data allows one teacher's student engagement levels to be compared with another's, or against the average for the school. Reporting thresholds can be set for this data and trend analysis can also trigger alerts. This in turn provides unique data for staff professional development. The questions and stimuli of teachers getting successful engagement levels can be analysed in detail or via aggregated reports and compared against those which the system identifies as needing assistance.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of is illustrative example of the invention and that all such modifications and variations thereto as would be apparent to persons of skill in the art are deemed to fall within the broad scope and ambit of the invention as herein set forth.

1. A system for responsive teaching and learning comprising:
an educator module that provides an educator interface facilitating uploading of lesson content by an educator;
a lesson content database in communication with said educator module and adapted to receive said lesson content from said educator;
a student module adapted to receive said lesson content and providing a student interface facilitating responses to said lesson content from students within a student population;
a response database in communication with said student module and adapted to receive said responses from said students;
a response management module that identifies responses made by students within said student population and, upon substantially receiving a predetermined minimum response requirement from a student, releases responses substantially anonymously from other students within said student population to that student thereby facilitating substantially anonymous interaction between students;
wherein said responses from said students and said substantially anonymous interactions are available to said educator whereby said responses and said anonymous interactions can be analyzed by said educator and students within said student population grouped based on said responses and said anonymous interactions.

2. A system as claimed in claim 1, wherein said lesson content comprises audio, video or images recorded by said educator on an educator device, and/or content sourced from an external source.

3. A system as claimed in claim 1, wherein said response management module releases responses from said students across said student population when all of said students within said student population have satisfied said predetermined minimum response requirement.

4. A system as claimed in claim 1, wherein said response management system releases responses from students within said student population only to students who have fulfilled said predetermined minimum response requirement.

5. A system as claimed in claim 4, wherein said released responses are limited to responses from students who have fulfilled said predetermined minimum response requirement.

6. A system as claimed in claim 1, wherein said anonymous interactions comprise tagging student responses with one or more of the group comprising “Agree”, “Disagree”, “Helpful”, “Like”, “Me Too”, and/or comments on student responses.

7. A system as claimed in claim 1, additionally comprising a dashboard adapted to collate learning data generated from said responses and said anonymous interactions from one or more student population.

8. A method for responsive teaching and learning comprising;
delivering lesson content from an educator interface to student interfaces within a student population;
establishing a predetermined minimum response requirement from students within said student population;
receiving responses from said students within said student population, through said student interfaces;
substantially identifying when a student satisfies said predetermined minimum response requirement;
when a student within said student population satisfies said predetermined minimum response requirement, making available to that student through their respective student interface, substantially anonymously, responses from other students within said student population;
receiving substantially anonymous interactions from students within said student population relating to responses from other students within said student population; and
based on said responses from students and said substantially anonymous interactions, establishing student groupings within said student population.

9. A method as claimed in claim 8, wherein said lesson content comprises audio, video or images recorded by said educator on an educator device, and/or content sourced from an external source.

10. A method as claimed in claim 8, wherein student responses are released from said students across said student population when all of said students within said student population have satisfied said predetermined minimum response requirement.

11. A method as claimed in claim 8, wherein responses are released from students within said student population only to students who have fulfilled said predetermined minimum response requirement.

12. A method as claimed in claim 11, wherein said released responses are limited to responses from students who have fulfilled said predetermined minimum response requirement.

13. A method as claimed in claim 8, wherein said anonymous interactions comprise tagging student responses with one or more of the group comprising “Agree”, “Disagree”, “Helpful”, “Like”, “Me Too”, and/or commenting on student responses.

14. A method as claimed in claim 8, additionally comprising collating learning data generated from said responses and said anonymous interactions from one or more student population.

15. A computer readable medium containing programming instructions that cause a computer processor to perform the steps of:
delivering lesson content from an educator interface to student interfaces within a student population;
establishing a predetermined minimum response requirement from students within said student population;
substantially identifying when a student satisfies said predetermined minimum response requirement;
when a student within said student population satisfies said predetermined minimum response requirement, making available to that student through their respective student interface, substantially anonymously, responses from other students within said student population;
facilitating substantially anonymous interactions from students within said student population relating to responses from other students within said student population; and
based on said responses from students and said substantially anonymous interactions, enabling student groupings within said student population.
